(19) United States
(12) Patent Application Publication
(10) Pub. No.: US 2021/0347169 A1
(43) Pub. Date: Nov. 11, 2021

(54) FLUIDIC DEVICE WITH NOZZLE LAYER CONDUCTORS

(71) Applicant: Hewlett-Packard Development Company, L.P., Spring, TX (US)

(72) Inventors: James R. Przybyla, Corvallis, OR (US); Eric Martin, Corvallis, OR (US); Daryl E. Anderson, Corvallis, OR (US); Chien-Hua Chen, Corvallis, OR (US)

(73) Assignee: Hewlett-Packard Development Company, L.P., Spring, TX (US)

(21) Appl. No.: 17/251,967

(22) PCT Filed: Jan. 31, 2019
(86) PCT No.: PCT/US2019/016110

§ 371 Date: Dec. 14, 2020

(51) Int. Cl. B41J 2/14; B41J 2/16

(52) U.S. Cl. CPC B41J 2/1433; B41J 2/164; B41J 2/162

(57) ABSTRACT

One example provides a fluidic device including a substrate, a nozzle layer disposed on the substrate, the nozzle layer having an upper surface opposite the substrate including a plurality of nozzles formed therein, each nozzle including a fluid chamber and a nozzle orifice extending through the nozzle layer from the upper surface to the fluid chamber. A number of conductive traces are disposed in direct contact with the nozzle layer to provide electrical pathways above the substrate.

### BACKGROUND

Fluidic devices, such as fluidic dies, for example, include a nozzle layer (e.g., an SU8 layer) in which a plurality of nozzles may be formed, with each nozzle including a fluid chamber and a nozzle orifice extending from a surface of the nozzle layer to the fluid chamber and through which fluid drops may be ejected from the fluid chamber. Some example fluidic devices may be printheads, where a fluid within the fluid chambers may be ink.

### BRIEF DESCRIPTION OF THE DRAWINGS

FIG. 1 is a cross-sectional view generally illustrating a fluidic device, according to one example.

FIG. 2 is a cross-sectional view generally illustrating a fluidic device, according to one example.

FIGS. 3A-3B are top views generally illustrating a fluidic device, according to one example.

FIG. 4 is a cross-sectional view generally illustrating a fluidic device, according to one example.

FIG. 5 is a block and schematic diagram generally illustrating a printhead including a fluidic device, according to one example.

FIG. 6 is a flow diagram generally illustrating a method of forming a fluidic device, according to one example.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Examples of fluidic devices, such as fluidic dies, for instance, may include fluid actuators. Fluid actuators may include thermal resistor based actuators, piezoelectric membrane based actuators, electrostatic membrane actuators, mechanical/impact driven membrane actuators, magneto-strictive drive actuators, or other suitable devices that may cause displacement of fluid in response to electrical actuation. Example fluidic dies described herein may include a plurality of fluid actuators, which may be referred to as an array of fluid actuators. An actuation event or firing event, as used herein, may refer to singular or concurrent actuation of fluid actuators of a fluidic die to cause fluid displacement.

Example fluidic dies may include fluid channels, fluid chambers, orifices, fluid holes, and/or other features which may be defined by surfaces fabricated in a substrate and other material layers of the fluidic die such as by etching, microfabrication (e.g., photolithography), micromachining processes, or other suitable processes or combinations thereof. Some example substrates may include silicon-based substrates, glass-based substrates, gallium-arsenide-based substrates, and/or other such suitable types of substrates for microfabricated devices and structures.

As used herein, fluid chambers may include ejection chambers in fluidic communication with nozzle orifices from which fluid may be ejected, and fluidic channels through which fluid may be conveyed. In some examples, fluidic channels may be microfluidic channels where, as used herein, a microfluidic channel may correspond to a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.).

In some examples, a fluid actuator may be arranged as part of a nozzle where, in addition to the fluid actuator, the nozzle includes an ejection chamber in fluidic communication with a nozzle orifice. The fluid actuator is positioned relative to the fluid chamber such that actuation of the fluid actuator causes displacement of fluid within the fluid chamber that may cause ejection of a fluid drop from the fluid chamber via the nozzle orifice. Accordingly, a fluid actuator arranged as part of a nozzle may sometimes be referred to as a fluid ejector or an ejecting actuator.

In one example nozzle, the fluid actuator comprises a thermal actuator, where actuation of the fluid actuator (sometimes referred to as “firing”) heats fluid within the fluid chamber to form a gaseous drive bubble therein, where such drive bubble may cause ejection of a fluid drop from the fluid chamber via the nozzle orifice (after which the drive bubble collapses). In one example, the thermal actuator is spaced from the fluid chamber by an insulating layer. In one example, a cavitation plate may disposed within the fluid chamber, where the cavitation plate is positioned to protect material underlying the fluid chamber, including the underlying insulating material and fluid actuator, from cavitation forces resulting from generation and collapse of the drive bubble. In examples, the cavitation plate may be metal (e.g., tantalum). In some examples, the cavitation plate may be in contact with the fluid within the fluid chamber.

In some examples, a fluid actuator may be arranged as part of a pump where, in addition to the fluidic actuator, the pump includes a fluidic channel. The fluidic actuator is positioned relative to a fluidic channel such that actuation of the fluid actuator generates fluid displacement in the fluid channel (e.g., a microfluidic channel) to convey fluid within the fluidic die, such as between a fluid supply (e.g., fluid slot) and a nozzle, for instance. A fluid actuator arranged to convey fluid within a fluidic channel may sometimes be referred to as a non-ejecting actuator. In some examples, similar to that described above with respect to a nozzle, a metal cavitation plate may be disposed within the fluidic channel above the fluid actuator to protect the fluidic actuator and underlying materials from cavitation forces resulting from generation and collapse of drive bubbles within the fluidic channel.

Fluidic dies may include an array of fluid actuators (such as columns of fluid actuators), where the fluid actuators of the array may be arranged as fluid ejectors (i.e., having corresponding fluid ejection chambers with nozzle orifices) and/or pumps (having corresponding fluid channels), with selective operation of fluid ejectors causing fluid drop ejection and selective operation of pumps causing fluid displacement within the fluidic die. In some examples, the array of fluid actuators may be arranged into primitives.

Fluid dies may include a nozzle layer (e.g., an SU8 photoresist layer) disposed on a substrate (e.g., a silicon substrate) with the fluid chamber and nozzle orifice of each nozzle being formed in the nozzle layer. In one example, the SU8 layer has first surface (e.g., a lower surface) disposed on the substrate (facing the substrate), and an opposing second surface (e.g., an upper surface) facing away from the substrate. In one example, the fluid chambers of each nozzle are formed within the nozzle layer, with the fluid chambers being disposed below the upper surface, and with a corresponding nozzle orifice extending through the nozzle layer from the upper surface to each fluid chamber, where fluid drops may be ejected from the fluid chambers via the corresponding nozzle orifice. The fluid may comprise any number of fluid types including ink and biological fluids, for example.

During operation of the fluidic die, operating conditions of the nozzles and the nozzle layer may adversely impact a quality of fluid ejection from the nozzles. For example, the nozzle layer may become cracked or damaged (e.g., through contact with imaging media), fluid or other debris may collect on the upper surface and interfere with fluid ejection, temperatures outside of a desired range may result in solidification of fluids or result in a variation in properties in ejected drops, and conditions within the nozzles may hinder nozzle performance (e.g., fluid temperature, blockages, insufficient heating).

Present techniques for monitoring nozzle operating conditions include drop detection techniques (e.g., electrical, optical) and scanning printed output for defects, for example. However, drop detection techniques are limited in the types of defects that are detectable, and scanning printed output is time consuming and expensive, and drive bubble detect does not monitor surface conditions. Thermal sensors may also be employed, but such sensors are locating in wiring layers below the nozzle layer such that sensed temperatures represent an approximation of surface temperatures based on known thermal characteristics of the overlying material.

According to examples of the present disclosure, a number of conductive traces are disposed in direct contact with the nozzle layer, where such conductors provide electrical pathways above the substrate on which the nozzle layer is disposed. In some examples, the conductive traces may provide pathways for electrical power and signal routing.

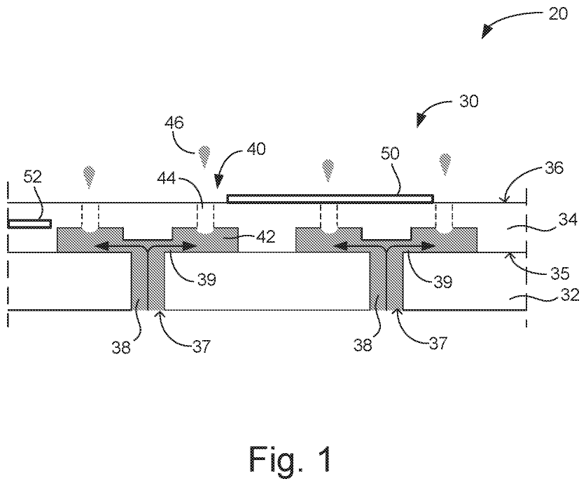

FIG. 1 is a cross-sectional view generally illustrating portions of a fluidic device 20, such as a fluidic die 30, including a number (one or more) of conductive traces disposed in contact with a nozzle layer, in accordance with one example of the present application. According to the example of FIG. 1, fluidic die 30 includes a substrate 32, such as a silicon substrate, with a nozzle layer 34 disposed thereon. In one example, nozzle layer 34 has a first surface 35 (e.g., a lower surface) disposed on substrate 32, and an opposing second surface 36 (e.g., an upper surface). In one example, nozzle layer 34 comprises an SU-8 material.

Nozzle layer 34, includes a plurality of nozzles 40 formed therein, with each nozzle 40 including a fluid chamber 42 disposed within nozzle layer 34 and a nozzle orifice 44 extending through the nozzle layer 34 from upper surface 36 to fluid chamber 42. In one example, substrate 32 includes a plurality of fluid feed holes 37 to supply fluid 38 (e.g., ink, biologic material) from a fluid source to fluid chambers 42 of nozzles 40 via a channel or passageway 39. In operation, nozzles 40 selectively eject fluid drops 46 from fluid chamber 42 via nozzle orifices 44.

As described above, according to examples of the present disclosure, a number of conductive traces are disposed in direct contact with nozzle layer 34. In one case, a conductive trace 50 disposed on and extends across upper surface 36 of nozzle layer 34. In another case, a conductive trace 52 is embedded within nozzle layer 34. As will be described in greater detail below, other conductive traces may be disposed at different locations on or within nozzle layer 34, such as on various surfaces of nozzle layer 34 or embedded at various locations within nozzle layer 34. Such conductive traces, as represented by conductive traces 50 and 52, may be made of any suitable conductive material, including Al, Cr/Au, Ta, Ti, and doped polysilicon, for example.

Conductive traces in contact with nozzle layer 34, as illustrated by example conductive traces 50 and 52, provide pathways for electrical power and signal routing for fluidic die 30 beyond the confines of substrate 32 (e.g., above substrate 32), and may provide electrical signals for detecting damage to nozzle layer 34, for monitoring operations and operating conditions of nozzles 40, for monitoring operating conditions of nozzle layer 34 (e.g., presence of damage, temperature), and may provide terminals for electrical connections to external devices, for instance. Conductive traces disposed in or on nozzle layer 34 also enable routing of electrical pathways over fluid pathways within substrate 32, such as fluid holes 37 and channels 39, for example.

By disposing conductive traces in direct contact with nozzle layer 34, operating conditions of nozzles 40 and nozzle layer 34 may be more directly monitored (rather than approximated by remote sensors), and routing of power and signals pathways through the nozzle layer may save space within substrate 32, thereby potentially enabling fluidic die 30 to be smaller in size.

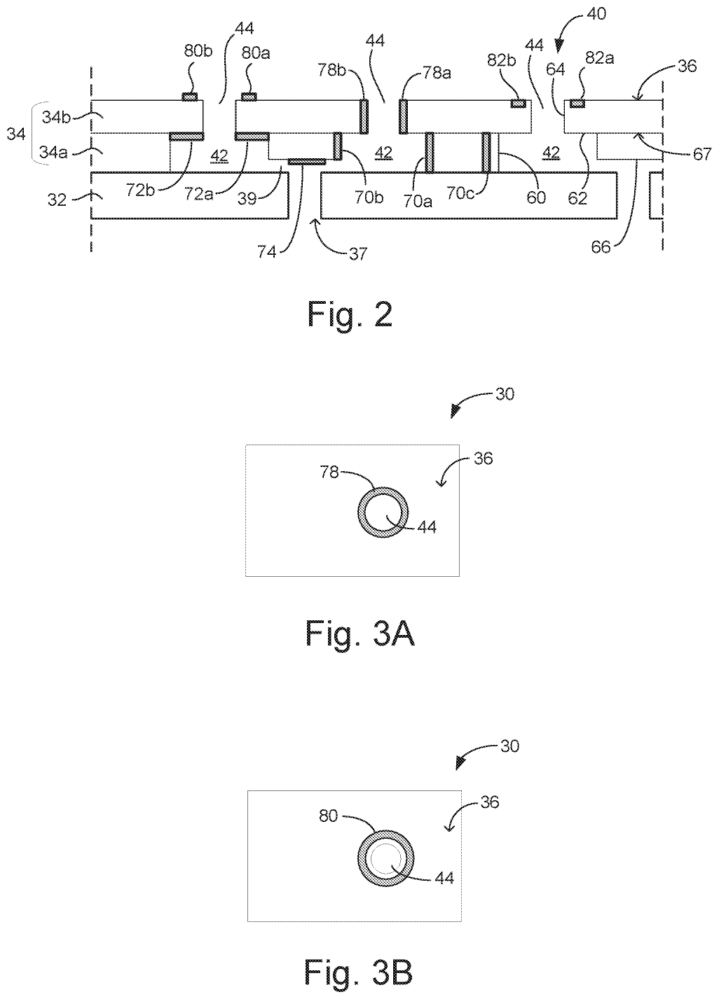

FIG. 2 is a cross-sectional view generally illustrating portions of fluidic die 30, in accordance with one example of the present application. In one example, as illustrated, nozzle layer 34 includes multiple layers, including a chamber layer 34a in which fluid chambers 42 are formed, and an orifice layer 34b in which nozzle orifices 44 are formed. As illustrated, each nozzle 40 includes various surfaces. For example, fluid chambers 42 include sidewall surfaces 60 and ceiling surfaces 62, while nozzle orifices 44 include orifice sidewall surfaces 64. In one example, fluid channels 39 may include a ceiling surface, as illustrated at 66.

In accordance with examples of the present disclosure, conductive traces 70a and 70b are disposed on sidewalls 60 of fluid chambers 42, and conductive traces 72a and 72b are disposed on ceiling surfaces 62 of fluid chambers 42, where ceiling surfaces 62 represent portions of a lower surface 67 of orifice layer 34b. In some cases, ceiling traces 72a and 72b are formed by depositing conductive traces 72a and 72b on a sacrificial layer (e.g., a wax material) disposed within already formed fluid chambers 42 in chamber layer 34a, with orifice layer 34b being deposited on top of chamber layer 34a and the sacrificial layer being subsequently removed so that traces 72a and 72b form a ceiling of fluid chambers 42. In one example, a conductive trace 74 is disposed on a ceiling of fluid passage way 39.

In one example, each of the conductive traces 70a, 70b, 72a, 72b, and 74 may be in direct contact with fluid 38 (see FIG. 1) and, in some cases, may be used to sense a presence of fluid 38 or an operating condition of fluid 38 (e.g., temperature) at their respective location. In other examples, such conductive traces may be disposed so as to not directly contact fluid 38, such as illustrated by conductive trace 70c, which is illustrated as being spaced from sidewall 60 of fluid chamber by a portion of chamber layer 34a.

Although illustrated as separate conductive traces, in some examples, conductive traces 70a and 70b represent portions of a continuous conductive trace extending about an interior perimeter of fluid chamber 42. Similarly, while illustrated as separate conductive traces, in some examples, conductive traces 72a and 72b represent portions of a continuous ring-like conductive trace that concentrically encircles nozzle orifice 44.

In one example, conductive traces 78a and 78b are disposed on sidewall surfaces 64 of nozzle orifices 44. In other cases, conductive traces 80a and 80b are disposed on upper surface 36 of nozzle layer 34b proximate to and on opposing sides of nozzle orifice 44. In other examples, similar to conductive traces 80a and 80b, conductive traces 82a and 82b are embedded within orifice layer 34b on opposing sides of nozzle orifices 44 with at least a portion of conductive traces 82a and 82b exposed to upper surface 36 (e.g., conductive traces 82a and 82b are partially embedded within orifice layer 34b. In some examples, conductive traces 80a, 80b and 82a, 82b may be disposed so as to be set back from a perimeter of nozzle orifices 44 so as to not contact fluid ejected from corresponding nozzle orifice 44, as illustrated by conductive traces 82a and 82b, or disposed at least flush with sidewalls 64 of nozzle orifices 44 so as to contact fluid being ejected from corresponding nozzle orifice 44, as illustrated by conductive traces 80a, 80b.

Although illustrated as separate conductive traces, in some examples, as illustrated by FIG. 3A, conductive traces 78a, 78b may represent portions of a continuous conductive trace 78 extending about an interior perimeter of nozzle orifice 44. Similarly, while illustrated as separate conductive traces, conductive traces 80a, 80b and conductive traces 82a, 82b may each represent portions of a continuous conductive trace extending about a perimeter of nozzle orifice 44, such as conductive traces 80a, 80b representing portions of a continuous conductive trace 80 disposed concentrically about nozzle orifice 44, as illustrated by FIG. 3B.

Conductive traces 78a, 78b, 80a, 80b, 82a, 82b, in some examples, may be employed to detect a presence of fluid 38 within or being ejected from nozzle orifices 44, may be employed to alter movement of fluid 38 within or being ejected from nozzle orifices 44, and conductive traces 80a, 80b, 82a, 82b may be employed to sense operating conditions at upper surface 36 (e.g., temperature, presence of damage, presence of debris).

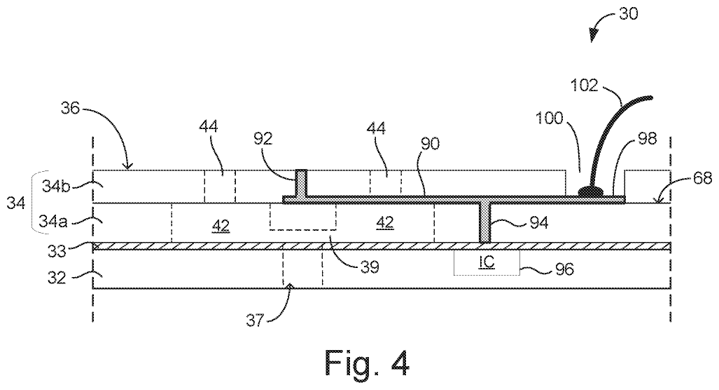

FIG. 4 is a cross-sectional view generally illustrating portions of fluidic die 30, in accordance with one example of the present application. As illustrated, in one example, fluidic die 30 includes a thin-film layer 33, including a plurality of metal wiring layers, disposed on substrate 32, between substrate 32 and chamber layer 34a.

In one example, as illustrated, a conductive trace 90 is disposed between chamber layer 34a and orifice layer 34b. In one case, conductive trace 90 may be deposited on upper surface 68 of chamber layer 34a, with orifice layer 34b being subsequently deposited thereon. In some cases, conductive trace 90 extends across chamber layer 34a above substrate 32, and provides a conductive pathways for power and signal routing above fluid paths, such as across fluid holes 37 and passages 37.

In one example, one or more vias 92 extend through orifice layer 34b from upper 36 to conductive trace 90 to enable conductive trace 90 to electrically connect to devices at upper surface 36 of orifice layer 34b. In other examples, one or more vias 94 extend through chamber layer 34a and electrically connect conductive trace 90 to thin-film layer 33 which, in turn, electrically connects to integrated circuitry within substrate 32, such illustrated by integrated circuitry 96. In some examples, conductive trace 90 and via 92 and 94 enable electrical connection between conductive traces 80a, 80b and 82a, 82b on upper surface 36, orifice conductors 78a, 78b, and fluid chamber conductors 72a, 72b (as illustrated by FIG. 2) and thin-film layer 33.

In one example, an opening 100 in orifice layer 34b exposes a portion 98 of conductive trace 90, where portion 98 may be employed as a terminal for connecting to external devices, such as illustrated by wire 102, with external connection 102 providing power and signal routing between fluidic die 30 and external devices.

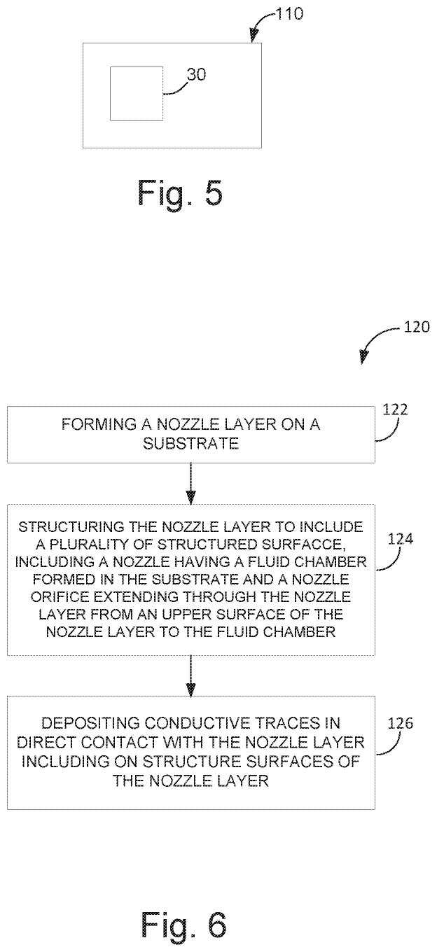

FIG. 5 is a block and schematic diagram generally illustrating a printhead 110 including a fluidic die 30 having a plurality of conductive traces disposed in direct contact nozzle layer 32, such as described by FIGS. 1-4. In one example, electrical power, communication, and monitoring signals may be communicated by printhead 110 to/from fluidic device 30 via the nozzle layer conductors. In examples, printhead 90 may be part of a printing system.

FIG. 6 is a flow diagram generally illustrating a method 120 of forming a fluidic device, according to examples of the present disclosure. At 122, method 120 includes forming a nozzle layer on a substrate, such as forming nozzle layer 134 on substrate 132, as illustrated by FIG. 1. At 124, the method includes structuring the nozzle layer to include a plurality of structured surfaces, including a nozzle having a fluid chamber formed in the substrate and a nozzle orifice extending through the nozzle layer from an upper surface of the nozzle layer to the fluid chamber, the upper surface opposite the substrate, such as forming nozzles 40 having fluid chambers 42 and a nozzle orifices 44 extending through nozzle layer 34 from upper surface 36 to fluid chamber 44, as illustrated by FIGS. 1-4, for examples.

At 126, method 120 including depositing conductive traces in direct contact with the nozzle layer, including on structured surfaces of the nozzle layer, such as depositing conductive traces 70a, 70b, 72a, and 72b on surfaces of fluid chamber 42, conductive traces 78a, 78b on interior sidewalls of nozzle orifice 44, and conductive traces 80a, 80b, 82a, and 82b exposed at upper surface 36.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A fluidic device comprising:
a substrate;
a nozzle layer disposed on the substrate and having an upper surface opposite the substrate, the nozzle layer including a plurality of nozzles formed therein, each nozzle including a fluid chamber and a nozzle orifice extending through the nozzle layer from the upper surface to the fluid chamber; and
a number of conductive traces disposed in direct contact with the nozzle layer to provide electrical pathways above the substrate.

2. The fluidic device of claim 1, the fluid chamber including sidewalls extending vertically to the upper surface of the nozzle layer, a sidewall conductive trace disposed on the sidewalls of the fluid chamber so as to be in contact with fluid within the fluid chamber.

3. The fluidic device of claim 2, the sidewall conductive trace disposed about an interior perimeter of the fluid chamber.

4. The fluidic device of claim 1, the fluid chamber including a ceiling, a ceiling conductive traced disposed on the fluid chamber ceiling.

5. The fluidic device of claim 4, the ceiling conductive trace disposed concentrically about the nozzle orifice.

6. The fluidic device of claim 1, including an orifice conductive trace disposed on a sidewall of the nozzle orifice.

7. The fluidic device of claim 1, including a conductive trace disposed proximate to a perimeter of the nozzle orifice and exposed to the upper surface of the nozzle layer.

8. The fluidic device of claim 7, the conductive trace disposed concentrically about the nozzle orifice.

9. The fluidic device of claim 1, a horizontal conductive trace embedded within the nozzle layer and extending horizontally to the substrate.

10. The fluidic device of claim 9, an opening extending through the nozzle layer from the upper surface to expose a portion of the horizontal conductive trace, the exposed portion to provide a contact pad for electrical connection to external devices.

11. The fluidic device of claim 9, a via extending through the nozzle layer from the upper surface of the horizontal conductive trace to provide an electrical pathway from the upper surface to the horizontal conductor.

12. The fluidic device of claim 9, a via extending through the nozzle layer from the horizontal conductive trace to provide an electrical pathway from the horizontal conductive trace to the substrate.

13. A fluidic device comprising:
a substrate;
a nozzle layer disposed on the substrate opposite, the nozzle layer including a plurality of nozzles formed therein, each nozzle including a fluid chamber and a nozzle orifice; and
a conductive trace disposed on an interior surface of one of the fluid chamber and the nozzle orifice.

14. A method of forming a fluidic device, including:
forming a nozzle layer on a substrate;
structuring the nozzle layer to include a plurality of structured surfaces, including a nozzle having a fluid chamber formed in the substrate and a nozzle orifice extending through the nozzle layer from an upper surface of the nozzle layer, the upper surface opposite the substrate, to the fluid chamber; and
depositing conductive traces in direct contact with the nozzle layer including on structured surfaces of the nozzle layer.

15. The method of claim 14, where the structured surfaces include sidewall and ceiling surfaces of the fluid chamber, interior sidewall surfaces of the nozzle orifice, the upper surface of the nozzle layer, within a recess in the upper surface, and on an upper surface of a chamber layer of the nozzle layer between the chamber layer and an orifice layer of the nozzle layer.
